(19) United States
(12) Patent Application Publication
(10) Pub. No.: US 2018/0037319 A1
(43) Pub. Date: Feb. 8, 2018

(54) VERTICAL TAKE-OFF AND LANDING AIRCRAFT (VARIANTS)

(71) Applicant: Gevorg Serezhaevich NOROYAN, s. Anuchino (RU)

(72) Inventor: Gevorg Serezhaevich NOROYAN, s. Anuchino (RU)

(21) Appl. No.: 15/551,253

(22) PCT Filed: Feb. 15, 2016
(86) PCT No.: PCT/RU2016/000075

§ 371 Date: Aug. 15, 2017

(30) Foreign Application Priority Data
Feb. 16, 2015 (RU) 2015105088

(51) Int. Cl. B64C 29/00

(52) U.S. Cl. CPC B64C 29/0033; B64C 39/001

(57) ABSTRACT

The invention relates to aviation, and more particularly to designs for vertical take-off and landing aircraft. The present vertical take-off and landing aircraft comprises jet propulsion units containing compressors, overflow valves, air tanks, and a nuclear power plant. Turbines are provided with hybrid engines capable of running on electricity or liquid fuel. On the outside of the aircraft, each turbine is provided with a corrugated tip, consisting of two parts: a base and an extendable part. The bases of the tips are pivotally mounted on the turbine for rotation about their own axis and are coupled to a lateral orientation system for altering the pumping direction. The other part of the corrugated tip is coupled to an angle adjusting system, which, optionally, extends one side of the corrugated part outside the body in order to alter the pumping angle by more than 90 degrees from vertical to horizontal.

### CROSS-REFERENCE TO RELATED APPLICATIONS

The present patent application claims priority from International Application PCT/RU2016/000075 filed on 15 Feb. 2016, which claims priority from Russian Patent Application RU2015105088, filed on 16 Feb. 2015; said applications and their disclosures being incorporated herein by reference in their entireties

### FIELD OF INVENTION

The invention relates to aeronautical engineering, namely to a vertical take-off and landing aircraft (AC), and can be used in civil and military aviation, astronautics, as well as in any branch of mechanical engineering, to save fuel and increase the speed of seagoing ships.

### BACKGROUND

In terms of technical essence, the prior art which is closest to the claimed invention is the vertical take-off and landing aircraft according to RU 2266846 C2, B64C29/02, B64C21/04 (published on Dec. 27, 2005). This AC includes a reactive propulsion system located in the center of a flat and round- in-plan wing, which includes turbine compressors. The lifting power in the prior art AC is generated due to a difference in the static air pressure which acts on the AC from below, and the static pressure of the circular, radially divergent air jet acting on the AC from above.

The disadvantages of the said AC are its inability to provide sufficient lifting power and weight efficiency, including at high fuel consumption to relieve the static pressure from above, which reduces the AC economic efficiency and reliability.

### SUMMARY

The technical result of the claimed invention is the creation of an economical and reliable aircraft configured to reach an extraordinal speed and an unusual weight efficiency of the lifting power, able to move vertically, horizontally or at any angle of tilt using air jets, with the use of the headwind power.

This technical result is achieved by the fact that the vertical take-off and landing aircraft includes at least one row of vertical turbines that are installed vertically on the aircraft sides.

The turbines boost air from above AC and send the air jet downward under the AC, vertically or at an angle. The boosting angle from above and from below can be adjusted from vertical to horizontal.

By boosting air from above using the upper turbines, the upper atmospheric pressure is relieved, a thrust in the boosting direction is created, the counter air flow contributes to the operation of turbines (vacuum is formed in front of the aircraft), and the AC freely moves forward under the pressure of the air jet from behind.

The general form of the AC is similar to that of a flying saucer, i.e. the is upper half is configured to have the shape of a saucer turned upside down, and the lower half has the shape of a saucer or a rounded (spherical) surface or another known aircraft form. In addition, the AC can have the shape of a spacecraft.

The aircraft frame is built as a framework and assembled from a section material (tubes, channel bars) or from any other section material.

The frame is a one-piece structure. The frame can also be assembled from a plurality of parts that are mechanically fixed to each other, and the AC may have another, different form.

The AC can also be provided with a cabin, which is located in the AC hull and fixed to the hull framework. The cabin may include a cockpit, a passenger compartment, a cargo bay, etc. The cabin may be located in the middle or in any other part of the AC, so as to keep a gap between the cabin and the turbines for the passage of exhaust gases and air. In addition, the cabin has corridors with exits on all sides and sight windows. The cabin is protected from the airspace with two protective layers with an air cushion therebetween.

The sight windows and exits are additionally provided with a double protection from the airspace and the hull.

Between the cabin protection and the AC hull, there is a gap, and this space serves as a common air channel for all turbines, except for those turbines that directly boost the air jet from above and send it backward, bypassing the air gap around the cabin, and these turbines may be located at the edge of the AC horizontal plane.

The frame is configured so that, when moving forward horizontally or when moving vertically, the AC does not lose its stability. The center of gravity must coincide with the geometric center horizontally and it should be lower than the vertical line, with slight deviations.

The AC may be provided with stability wings, or may not have the same.

The frame is made of light metals and sheathed with a thin elastic metal.

The turbines may be installed at least in one row and are equally spaced around the AC perimeter.

The larger the number of AC turbines, the easier the stability control, and the easier the AC in emergency situations.

The number of AC turbines shall be overdesigned, so that the AC landing can be ensured even by a part of them; in each case for each AC, the turbine number and power shall be selected individually.

The last turbine row is installed on the AC sides vertically or at a slight angle, vertically in the direction of the center , or away of the center, regardless of the AC features. The tilt angle is also variable.

The larger the distance of the last turbines row from the center, the greater the AC stability.

There may be several rows of turbines on the AC, wherein every row is located at a certain distance from the center. The number of turbines and the distance between the rows shall be designed individually for each AC.

The last row or a plurality of rows (where the AC thickness allows this) of turbines can boost air from above and send the air jet downwards through the AC hull, whereas those turbines that are closer to the center and installed on the AC bottom vertically or at an angle (so that one side of a turbine corresponds to the plane of the AC spherical surface) boost air from above and send it to the AC hull. Other turbines, that are installed in the lower part of the AC, also vertically or at an angle, boost air from the AC hull and send the air jet downward.

In addition, the upper and lower turbines can be connected to each other by an air-duct channel, so that the upper turbines supply air to the lower turbines, and the lower turbines send the air jet upwards.

The AC can be designed so that the turbines are installed either in the upper part or in the lower part of the AC. In such a case, the turbines are connected to the opposite side by an air-duct channel.

The AC can be provided with horizontal motion turbines that are installed at any height of the AC. There can be a plurality of the lateral motion turbines.

The lateral motion turbines boost the air jet through the AC hull; at the fore end, some turbines boost air and send it to the AC hull, whereas at the after end, other turbines send the air jet backwards. In addition, the fore-end turbines can be connected to the after-end turbines by an air duct channel.

The AC can move horizontally, vertically or at an angle using the turbines that are installed vertically, if the turbines are provided with corrugated headpieces. The air intake corrugated headpieces allow for taking in the air flow not only vertically from above, but also from either side of the AC and at any angle. Moreover, the corrugated headpieces of the air intake and the nozzles allow for adjusting the AC direction. The corrugated headpieces are provided with motors that are connected to the control center and by any known method adjust the extension degree and extension direction of the corrugated headpieces. In addition, the corrugated headpieces can rotate around their axis using an automatic controller that is connected to the base of a corrugated headpiece and, if necessary, rotates it around its axis.

Each motion of the AC, at any angle and in any direction, is adjusted using the corrugated headpieces, with which EACH TURBINE is provided. Those turbines that do not change or constantly and equally change the orientation of the corrugated headpieces are grouped together. The corrugated headpieces may have a different known form and configuration for each group of turbines and individually for each turbine.

The corrugated headpieces consist of two parts: the base and the corrugated part.

The base of a corrugated headpiece is a ring-shaped gear with a border rim and is provided with a shaft on both sides, so that the blades rotate on the shafts.

From the turbine side, the corrugated headpiece base is provided with a border rim, which is inserted in the turbine casing or installed on the same and fixed with a fixing rim, a clamper (or by any other known method), so that it can rotate around its axis, if necessary.

The corrugated headpiece basement is connected to the turbine casing by a hinged joint, and it may be larger or smaller in diameter than the turbine diameter (to be designed individually).

The corrugated headpiece size is designed to provide the required volume and velocity of the air flow.

The corrugated headpiece base is installed on the turbine using a hinged joint and is fixed to the lateral orientation automatic controller that rotates it around its axis to change the boosting direction.

The corrugated headpiece base is parallel to the AC hull skin in the place of its installation, and can be also installed at a slight angle.

The corrugated part is connected to the automatic angle controller that, if necessary, pushes one side of the corrugated part from the hull with an arc, to change the boosting angle by over 90 degrees from the vertical to horizontal position.

The corrugated part of a headpiece consists of a plurality of blades having the shape of a spherical semicircle (an arc, see FIG. 5). The blades are installed on the shaft, with which the corrugated headpiece base is provided; in the middle, diagonally, or in any other place along the base ring.

The blades are of various size, so that one blades enter the other by turns; in the smallest blade, a gear is mechanically fastened to the inner side, and the gear in contact (the meshing gear) is connected to the automatic controller.

The smallest blade of a corrugated headpiece is the driving gear. At the edges of the smallest gear, a rim is mechanically fixed to the outer side on the back side in the travel direction. When moving outside, due to this rim (from the turbine side), the smallest blade engages the next one; the latter engages the next one, and so by turns, one after another. On each blade, a border rim is mechanically fastened on one or two sides, outside or inside, depending on the location, so as to provide the motion of the next blade both upwards and downwards.

The corrugated headpieces may have the shape of a corrugated pipe or any other known shape.

The shaft on the corrugated headpiece base may be located in the middle diagonally or in any other place along the ring, depending on the corrugated part size, which can be larger or smaller than the half the base circle.

The number and size of the blades on the corrugated part is also different.

For example, if the air intake on the driving turbines is raised to form a bend angle of over 45 degrees, the air flow intake is performed not from above, but from the fore end of the AC. The air flow intake angle from the fore end and the air jet direction can be adjusted. The angle of the corrugated headpieces orientation varies from zero to over 90 degrees (from the horizontal to over than vertical position).

The AC flies to the direction from where the turbines boost air.

The air jet direction from the after end may be straightly backwards or backwards an at angle in different directions for better stability and for an active control of the speed.

Depending on how you need to change the flight line, the AC may not rotate around its axis, but, when changing the direction, it can merely change the side and angle of the air boosting using the corrugated headpieces.

When changing the boosting direction and angle, the air jet orientation is automatically changed on the other, opposite side.

Turbines for the AC should be selected individually, depending on the required parameters and the target industry of the AC operation. In each case, a different approach and calculation shall be used.

The turbines operate so that, in case of a failure of one turbine, this could not affect the operation of other turbines.

The turbines are installed on the AC so that, in the case of a failure of even several turbines, it could not prevent the AC from keeping moving until landing.

The turbine blades are also selected individually and can have any known shape. The blades can be adjustable in terms of the air flow intake angle.

However, the most suitable turbines in this case are those with flat blades that feature an adjustable intake angle.

Each turbine is installed with an automatic device that raises or lowers one side of the blades widthwise within a range of up to 100 degrees; the blade tilt varies upwards from the horizontal position by up to 50 degrees or downwards from the horizontal position by up to 50 degrees.

Each of the blades is connected using the shaft by a hinged joint; the shaft is located in any place of the blade widthwise, and the automatic device levers are connected to blades by a hinged joint along the shaft length, so as to easily control the blade rotation.

The blades are made of flat metal having a trapezoid shape. The blades can also have a different shape, and in each case, they should be designed individually.

Given that the blades are made of flat metal, to ensure the blades strength, it is possible to install several automatic device levers on each blade at various distances from the shaft, or to design the blade strength so that it could withstand any load in this case.

The blades rotate around their axis by up to 100 degrees, upwards by up to 50 degrees, and downwards by up to 50 degrees.

The adjustable blades allow for changing the amount of the boosted air. When moving a blade from the horizontal line to the other side, the air jet direction changes by 180 degrees. The air is boosted from above and from below alternately, whereas the direction and the speed of the shaft rotation can remain the same.

For example, if the shaft rotates clockwise, when rising the right side above the horizontal line, the air is boosted from above, and when rising the left side, the air is boosted from below; the blade rotation angle can also be adjusted. The blade reverse when taking in and sending the air and the flexible motion of the air duct headpieces allow for instantly changing the AC heading at any angle.

The AC turbines suck and boost air alternately, thus ensuring a high maneuverability of the AC. The AC can ascend and descend sharply, or it can change its heading in a matter of seconds in any direction.

When moving horizontally, the upper and lower turbines, that are located at the after end of the AC, boost air from the AC hull and send the air jet backwards horizontally or at an angle, so as not to impact the AC stability and altitude, whereas the turbines at the after end of the AC boost air from the AC fore end and send it to the AC hull, also horizontally or at an angle, to maintain the AC stability. In such case, the angle of taking in and sending air determines the AC speed.

The AC shall be configured so that the center of gravity is located in the middle of the AC horizontally or bellows the AC center vertically.

The AC is provided with lighting lamps and sight windows on all sides.

In giant ACs, where the surface allows this, a nuclear power plant is installed, where the turbines are mainly electrically driven, whereas liquid fuel and compressed air are used in emergency situations, for example, for orientation in space and during emergency landings.

The nuclear power plant in the AC hull can be isolated from the cabin by protective walls, sufficient to ensure the safety of the crew and passengers.

Onboard computers monitor and adjust the tilt angle, as required at the given moment of time, and the side from where the air must be boosted, and the direction where the air flow must be boosted, individually for each group of turbines and for each turbine.

The rpm speed of each turbine is adjustable.

The stability device, with which the AC is provided, sends signals to onboard computers and, in case of any deviation of the AC stability, on the command of the onboard computers, increases or decreases the turbines rotation speed or the blade tilt angle, depending on the turbine location. For example, in case of overload of the right side, the right-side turbines increase the rotation speed, whereas the turbines of the left side, in contrast, decrease the rotation speed per revolution, in order to restore the AC stability.

It is also possible to control the AC stability using blades by changing the air intake angle. When changing the blade intake angle, the amount of the air flow changes from zero (at a horizontal position) to the maximum of 45 degrees.

Each turbine can be provided with stability devices, so that, with certain readings of the stability device, the turbine rotation speed and the blade intake angle automatically change to maintain the stability.

In addition, the air flow direction can be adjusted using the turbines themselves, if the turbines are configured to tilt with the use of the known adjusting devices.

The outermost turbine row mainly serves to maintain the AC stability and altitude. In case of a horizontal flight, corrugated headpieces of the last row turbines are adjusted so that air intake is performed at an angle to maintain the required altitude and to facilitate the horizontal motion.

All the turbines of the last row (or all the turbines) can be provided with hybrid engines, which can be driven by electricity, liquid fuel and compressed air. For each AC, such engines should be selected and designed individually.

The AC can be provided with air compressors, bypass valves, and receivers. The AC frame sections can be used as additional receivers. The accumulated air can be used both during an emergency landing and for orientation in space.

Each row or group of turbines can be provided with engines of different type and can operate using different types of fuels.

A part of turbines can be provided with starter-generators. When getting down, a part of turbines can be switched to the electric power generator and, using the counter air flow coming from below, the electric power generator generates electricity.

The AC moves in space, using the counter air flow. The turbines boost the counter air (headwind) backwards, thus relieving the headwind resistance; on the contrary, the AC, supported by it, rushes forward.

During the ascent, the turbines boost air from above, and the greater the area of the upper turbines, the lesser the upper atmospheric resistance.

In addition, the upper atmospheric resistance is relieved due to high-speed turbines that boost air not only in the form of a column from above, but also in the form of a cone.

To ensure the aircraft landing and parking, it can be provided with supports (such as parking legs) that are fastened to the lower frame using various known methods.

It is possible to make another AC embodiments.

Another embodiment is also possible, according to which the AC is configured with a flat upper part, whereas the lower part is saucer-shaped, and inversely, the upper part is saucer-shaped, whereas the bottom is flat.

Another embodiment is also possible, according to which the AC has the configuration of a spacecraft.

The aircraft shall be configured so that the center of gravity is lower (in terms of height) than the AC center. The main load is placed evenly to ensure the AC stability.

### BRIEF DESCRIPTION OF DRAWINGS

The claimed invention is explained using the following drawings.

FIG. 1 is the general plan view of the aircraft, with indication of the turbine locations with sight windows, where:

1 is the first row of turbines;

2 is the second row of turbines;

3 is the third row of turbines;

4 is the fourth row of turbines;

5 is the fifth row of turbines;

6 is the AC vertical axis (with the possible location of an emergency exit);

7 is the possible location of sight windows and exits.

FIG. 2 is the side view of the aircraft, where:

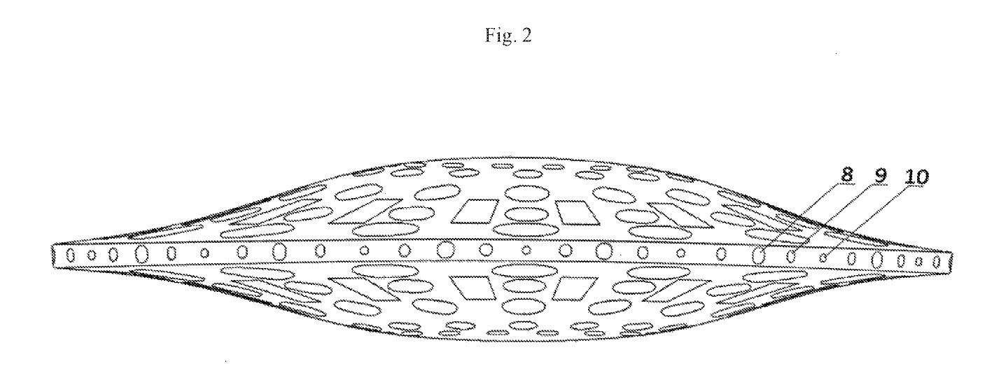

8 and 9 are possible sight windows and exits;

10 is the possible location of the horizontal motion turbines.

FIG. 3 shows the adjusting blades, where:

15 and the levers of the blade tilt-controlling device;

16 are the blades;

17 is the blade stiffener;

18 is the shaft on which the blades are fixed;

19 is the turbine arbor;

20 is a washer;

21 is a bearing;

22 is the blade tilt controlling device.

FIG. 4 is another variant of blades arrangement on the turbine arbor (a plan view).

FIG. 5 is a corrugated headpiece opened by more than 90 degrees, in B-B section in FIG. 7, where:

11 is the headpiece base (a gear);

12 is a gear to lift the corrugated headpiece blades;

13 is the shaft of the corrugated headpiece blades;

29 is the blowing blade of a corrugated headpiece.

FIG. 6 is an open view of a corrugated headpiece, A-A section in FIG. 7, where:

24 is the automatic device gear;

25 is the automatic device electric motor;

30 is a fixing rim;

31 is the turbine casing;

24 is a screw.

FIG. 7 is a schematic plan view of a corrugated headpiece.

FIG. 8 is a schematic section view of the AC from outside; the arrows show the air movement during lateral motion into the AC and away from the AC, where:

26 is the schematic view of the framework, the AC frame;

27 is the schematic arrangement of the cabin;

28 is the possible variants of exit corridors.

FIG. 9 is a schematic section view of the AC; the arrows show the air movement during vertical ascent into the AC hull and away from the AC hull.

FIG. 10 is the AC section view, where;

32 are possible locations of receivers;

33 is an air cushion between the cabin and the frame;

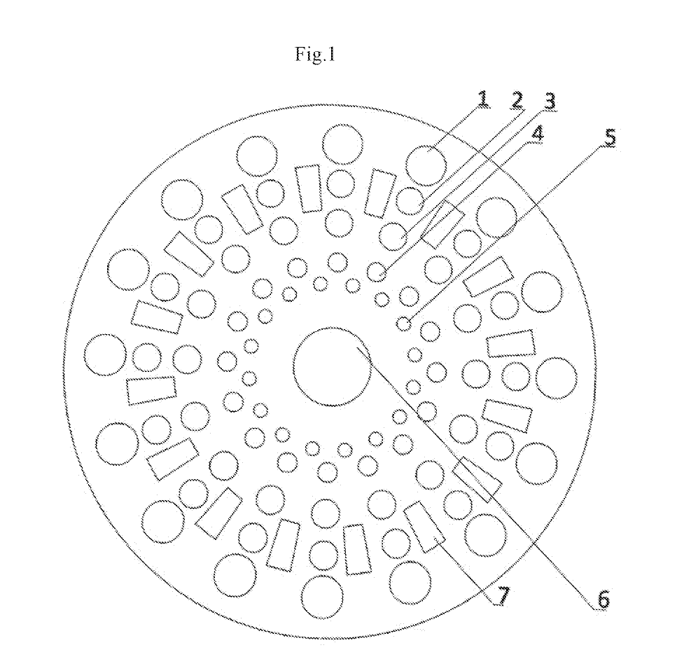

35 are locations of the last-row turbines from the central vertical axis of the AC; in FIG. 1 they are shown as 1;

35 is an air duct channel connecting a corrugated headpiece with a turbine.

### DETAILED DESCRIPTION OF THE PREFERRED EMBODIMENT

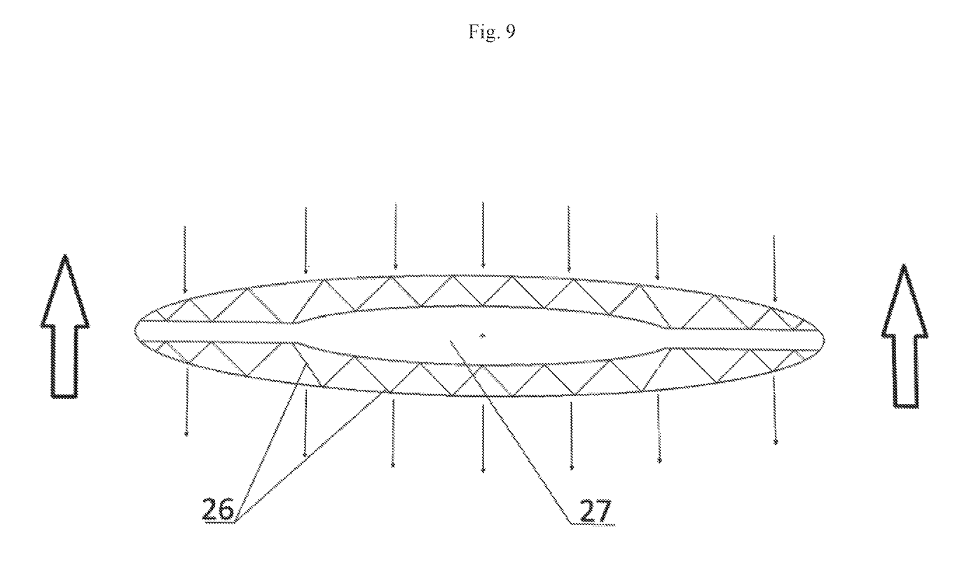

The cabin 27 of the aircraft is surrounded by a framework 26 on all sides for better structural strength and is sheathed with a thin elastic metal (not shown); turbines are integrated in all framework elements, so that there is a gap between the turbines and the cabin to ensure the passage of air masses, and so that one side of the turbines communicates with (is exposed to) the outer space, whereas the other side is inside the aircraft hull. The turbines are installed vertically or at an angle, so that the outer surface match the hull tilt in the installation location; the turbines number and size are various; the turbines 1, 2, 3, 4, and 5 are located evenly along the entire radius, and for better stability, starting from the end to the vertical axis center of the aircraft 6, depending on the aircraft size; turbines can be installed in multiple rows in a circle (FIG. 1), from top to bottom, whereas the AC upper part can be symmetrical to the lower part, with symmetrically installed turbines, through which air passes to relieve the upper atmospheric pressure of the aircraft during its ascent and to create a high atmospheric pressure under the aircraft (in FIG. 9, the movement of air masses is shown with thin arrows).

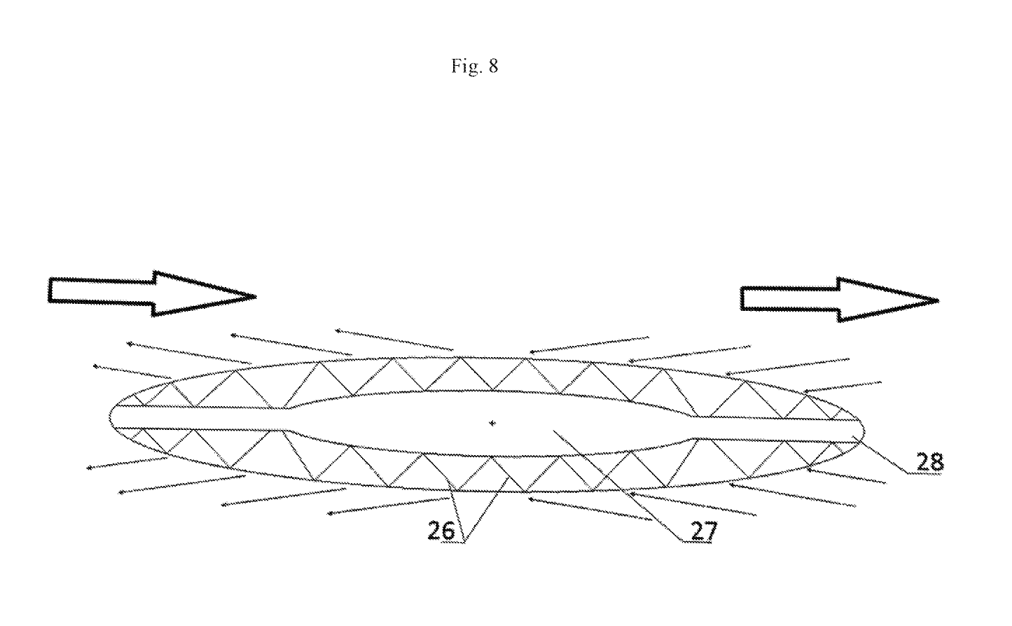

During a horizontal motion (in FIG. 8, it is shown with large arrows), air is boosted from the fore end, and the headwind resistance is relieved, whereas from the after end, an air jet creates a high pressure (in FIG. 9, it is shown with thin arrows), whereas the aircraft lower part is saucer-shaped, and the upper part has the shape of a saucer turned upside down. The AC can have any other known shape.

The upper and lower parts (halves) can be either symmetrical or different.

The turbines in the upper part can be arranged symmetrically with respect to the lower turbines, or they can be different, and they can feature various power.

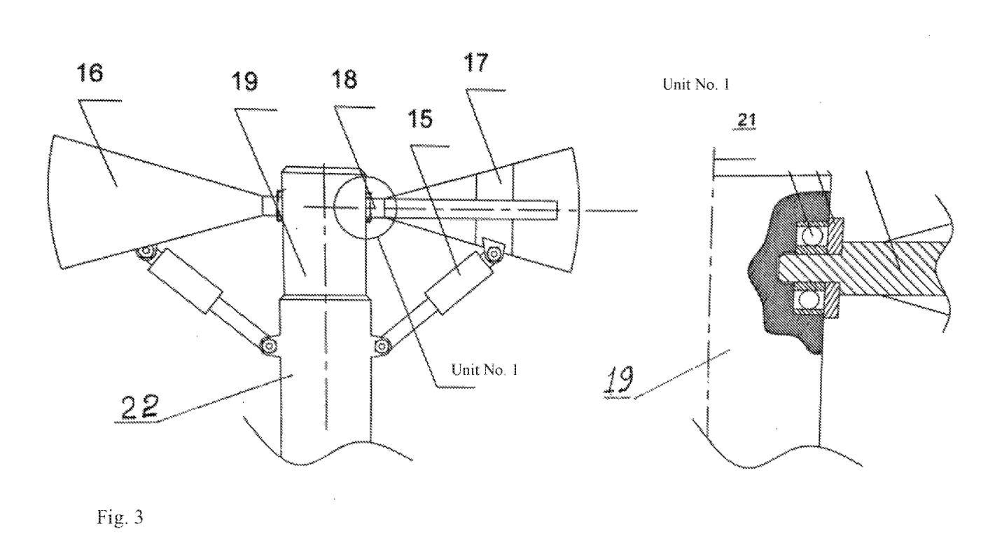

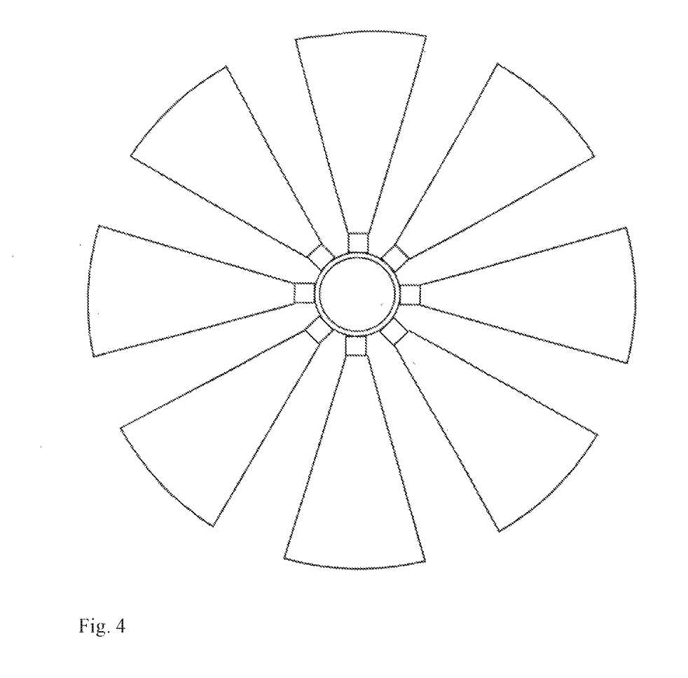

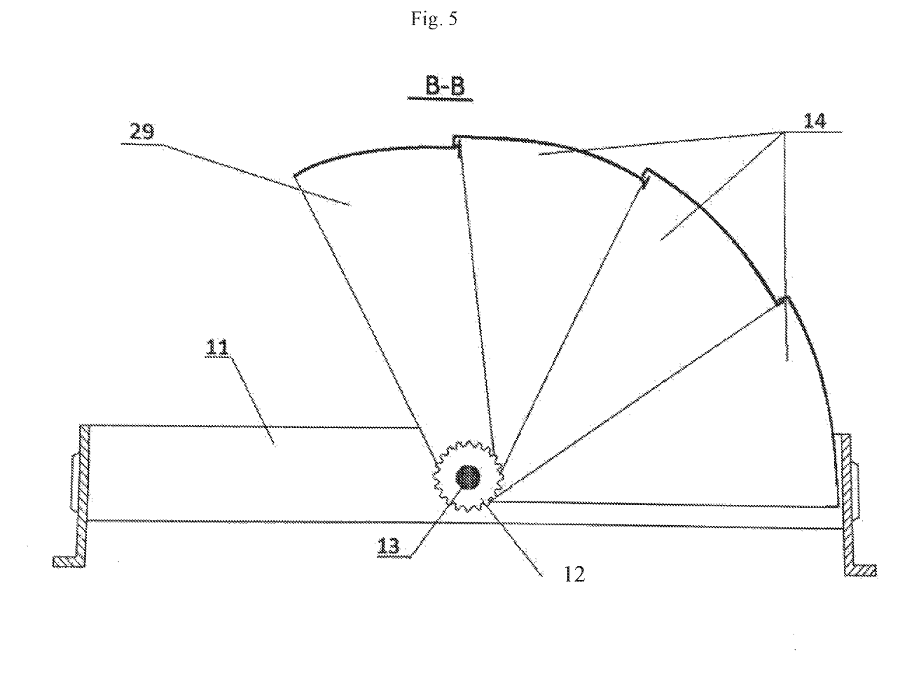

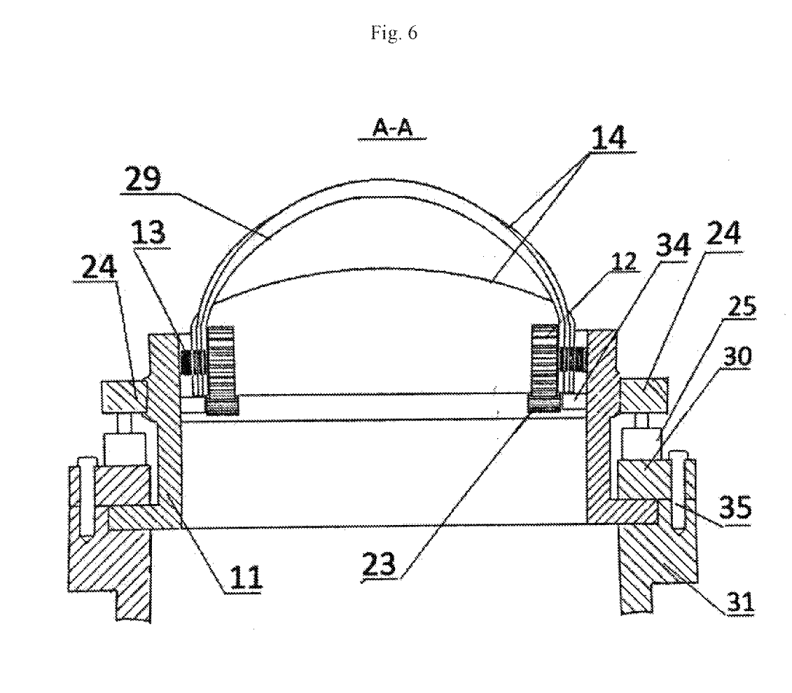

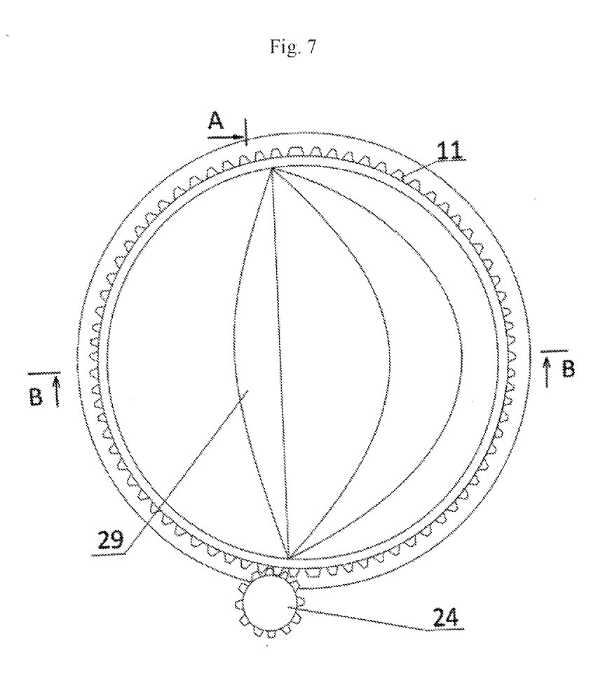

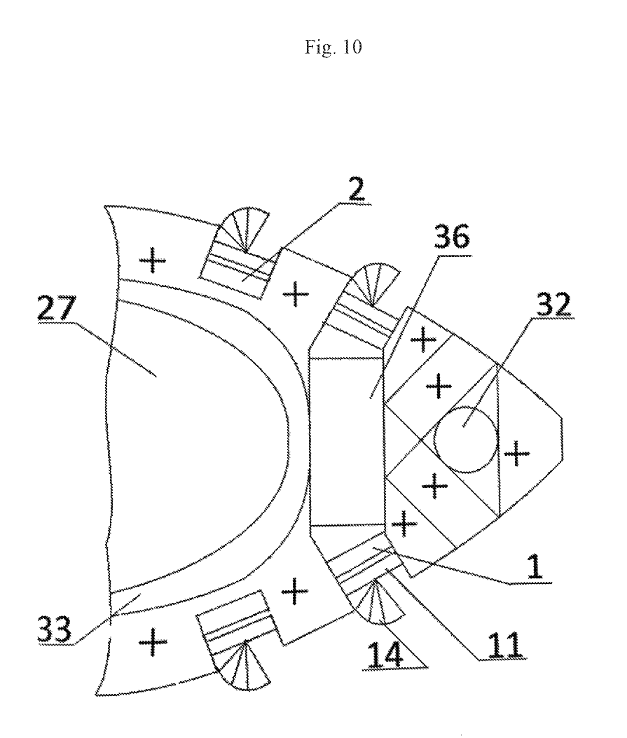

Each turbines outside the aircraft is provided with a corrugated headpiece; a corrugated headpiece (FIGS. 5, 6, and 7) consists of two parts: a base 11 and retractable parts 14 and 29; the corrugated headpiece base 11 is installed on the turbine using a shaft to rotate around its axis and is connected by a gear 24 with the lateral orientation automatic device 25 to change the boosting direction, whereas the second corrugated parts 14 and 29 are connected to the automatic angle controller 25 that, if necessary, pushes out one side of the corrugated part with an arc out of the hull (FIG. 5) to change the boosting angle by more than 90 degrees from vertical to horizontal position. Turbines are integrated into the hull vertically on the edges, evenly along the entire radius from the vertical axis center, so that the upper part of the turbine is fixed (connected) to the aircraft upper spherical surface, whereas the turbine lower part is fixed to the lower spherical surface to ensure the passage of air masses from above of the aircraft below the same through its hull to relieve the upper atmospheric pressure above the aircraft and to create a high pressure below the same, wherein each turbine can be provided with two corrugated headpieces from top to bottom (FIG. 10) to adjust the boosting direction and angle when moving horizontally or at an angle, as well as to change the angle and direction of the air jets behind the aircraft. The aircraft may be provided with various number of turbines of various power; they can be also installed at various distance from the center; there must be at least one row of turbines. The turbines are provided with adjustable blades (FIG. 3); the blades are made of flat and elastic material and have a trapezoid shape (FIG. 4) or another known shape of blades; the blades are fixed to the arbor by a hinged joint (Unit No. 1 in FIG. 3) using the shaft 18 that is mechanically fastened to the blades in any location widthwise, whereas the levers 15 of the automatic device 22, with which the arbor 19 is provided, are fastened to the blades by a hinged joint (not shown), so that they can freely rotate the blades around the shaft 18 by up to 100 degrees, upwards by up to 50 degrees from the horizontal position, and downwards by up to 50 degrees from the horizontal position to change the air jets direction by 180 degrees.

The automatic device can be fixed to each of the blades by two or more levers at various distances to ensure the blade strength.

The AC can be provided with wheels (not shown in the figures) of various number and shape, that are installed under the aircraft using known methods for traveling on roads and for take-off with acceleration to increase the aircraft load-lifting capacity.

The frame sections can be used as additional receivers during an emergency landing.

The disclosed vertical take-off and landing aircraft operates as follows.

The electric turbines are switched on. The air engines of the AC jet propulsion units are started; the working capacity of all the AC turbines is checked with the horizontal position of the blades. When the aircraft climbs, the corrugated headpieces are adjusted in the required direction. The blades are adjusted so that air boosting is close to the maximum value, with a simultaneous increase in the rotation speed. Simultaneously, all the turbines boost air from above and send the air jet downwards; the last turbine row boosts air from above through the hull and sends it backwards, the other upper central turbines boost air from above and send it into the AC hull, whereas the lower central turbines boost air from the AC hull and send it downwards; everything is done simultaneously, and, by joint efforts of all the turbines, the AC easily takes off. The synchronous operation of the turbines creates a low pressure above the AC and a high pressure below the same. The fore-end turbines pull, and the after-end turbines pushes the AC ahead. Moreover, the turbines can be initially adjusted in a certain direction.

All the turbines boost air from above AC, thus relieving the upper atmospheric pressure, whereas the lower turbines send the air jet downwards vertically, is a vertical taking-off is required.

In case of upward direction at an angle, all the corrugated headpieces are adjusted in one direction, independently of their location (both upper and lower headpieces); the upper turbines pull the AC upwards in the preset direction, whereas the lower turbines push the AC from behind in the same direction.

The AC speed and lifting power AC depends on the aggregate power of all the turbines and are adjusted using the blades; the blades tilt angle with a certain tilt of the corrugated headpieces determines the AC speed.

During horizontal motion, all the turbines can boost air or blow it out, so that it helps increase the AC speed by changing the boosting direction and the air jet orientation.

During horizontal descending motion, some or all turbines are switched to the electric power generator and generate electricity using the headwind force from below, the electricity being transmitted to accumulators.

The AC control center constantly monitors the operation of all the turbines, and their switching from one function to another one (from the electric power generators to the engines, and inversely), as well as the switching from the electric power to the liquid fuel in nuclear AC, if necessary. In addition, the control center constantly monitors and adjusts the corrugated headpieces tilt for each of the AC turbines.

The claimed AC can perform an emergency landing even from a great altitude without any damage, as each of the turbines is provided with at least one air engine and a separate receiver that are individually connected to one or more compressors. The air engines are switched on automatically at a certain speed of descent and maintain the required speed of landing, the engines being provided with a separate (emergency) control system.

The aircraft can be provided with legs to ensure the aircraft landing and parking.

The aircraft can be provided with wheels for travelling on roads.

The AC lifting power AC increases in times when taking off with acceleration.

1. A vertical take-off and landing aircraft, comprising:
jet propulsion power units that include compressors, bypass valves, wherein, to ensure long non-stop flights, the aircraft is provided with a nuclear electric power plant, and turbines are provided with hybrid engines configured to be driven both by electricity and liquid fuel.

2. The aircraft according to claim 1, wherein the turbines are provided with air engines that are connected to the compressors, receivers and the bypass valves and intended for orientation in space and for emergency landing.

3. A vertical take-off and landing aircraft, comprising:
jet propulsion power units that include compressors, bypass valves, wherein each of turbines outside the aircraft is provided with a corrugated headpiece, the corrugated headpiece consists of two parts: a base and a retractable part, the corrugated headpieces bases are installed on the turbines by a hinged joint to rotate around their axis and connected with a lateral orientation automatic device to change an air boosting direction, whereas a second corrugated part is connected to an automatic angle controlling device that, if necessary, push one side of the corrugated part out of a hull to change the boosting angle by more than 90 degrees from a vertical to a horizontal position.

4. A vertical take-off and landing aircraft, comprising:
jet propulsion power units that include compressors, bypass valves, wherein an aircraft cabin is surrounded by a framework on all sides for improved strength of the cabin and is sheathed with a thin elastic metal, whereas turbines are integrated into framework elements, so that there is a gap between the turbines and the cabin to ensure a passage of air masses, and so that one side of the turbines communicates with an outer space, and another side is installed inside aircraft hulls, the turbines are installed vertically or at an angle, so that their outer surface matches a hull tilt angle in a place of installation, a number of the turbines and their sizes are variable, the turbines are evenly arranged along an entire radius, for an improved stability, starting from an end to a center of an aircraft vertical axis, depending on an aircraft size, the turbine can be arranged in multiple rows in a circle, from a top to a bottom, through which an air passes to relieve an upper atmospheric pressure above the aircraft and to create a high atmospheric pressure under the aircraft, in order to increase a weight efficiency of a lifting power, and when moving horizontally, an air is boosted from a fore end to relieve a front resistance of a headwind, whereas an air jet at a back end creates a high pressure to increase a speed, where a lower part of the aircraft has a saucer-like shape, and an upper part also has also a shape of a saucer, but turned upside down, the aircraft can feature any other known shape.

5. The aircraft according to claim 3, wherein the turbines are integrated in the hull at edges, evenly along an entire radius from a center of a vertical axis, so that an upper part of the turbine is fixed to an upper spherical surface of the aircraft using an air duct channel, and a lower part of the turbine is fixed to a lower spherical surface of the aircraft, to ensure the passage of air masses from above of the aircraft below the same, in order to relieve a high atmospheric pressure above the aircraft and to create a high pressure below the aircraft, where each of the turbines is provided with two corrugated headpieces, from a top to a bottom, to adjust an air flow boosting direction and an angle above when moving horizontally or at an angle, as well as to change an air jet direction and an angle at a back end, there is optionally a plurality of the turbines on the aircraft that have various power and are installed at various distances from the center in at least one row.

6. The aircraft according to claim 5, wherein a frame section is used as additional receivers for an emergency landing or orientation in space.

7. A vertical take-off and landing aircraft comprising jet propulsion power units, comprising:
compressors, bypass valves, wherein turbines are provided with adjusting blades, the blades are made of flat and elastic materials and have a shape of a trapezoid or any other known shape of blades, the blades are connected to an arbor by a hinged joint using a shaft which is mechanically fixed to the blades in any location widthwise, whereas levers of an automatic device with which the arbor is provided, are connected to the blades by a hinged joint, so that it can free rotate the blades around its axis by up to 100 degrees, upwards by up to 50 degrees from a horizontal position, and downwards by up to 50 degrees from the horizontal position, to change an air jet direction by 180 degrees.

8. The aircraft according to claim 6, wherein an automatic device is connected to each of the blades and two or more levers at a variable distance to ensure a blade strength.
